(19) United States
(12) Patent Application Publication
(10) Pub. No.: US 2026/0117833 A1
(43) Pub. Date: Apr. 30, 2026

(54) DISC BRAKE CALIPER

(71) Applicant: BREMBO N.V., Bergamo (IT)

(72) Inventor: Fabio TROMBELLA, Bergamo (IT)

(73) Assignee: BREMBO N.V., Bergamo (IT)

(21) Appl. No.: 19/339,630

(22) Filed: Sep. 25, 2025

(30) Foreign Application Priority Data
Oct. 25, 2024 (IT) 102024000023868

(51) Int. Cl. F16D 65/18; B60T 13/58; F16D 55/00; F16D 55/226; F16D 65/00; F16D 121/04; F16D 121/24; F16D 123/00; F16D 125/08; F16D 125/40

(52) U.S. Cl. CPC F16D 65/18; B60T 13/588; F16D 55/226; F16D 65/0068; F16D 2055/0016; F16D 2121/04; F16D 2121/24; F16D 2123/00; F16D 2125/08; F16D 2125/40

(57) ABSTRACT

A disc brake caliper has a caliper body astride a brake disc having opposite friction surfaces, pads housed in the caliper body, a cylinder forming a cylindrical wall and a bottom wall, and a piston forming a side wall and a thrust wall. The piston is configured to be actuated by pressurized brake fluid, so as to bias at least one of the pads against one of the friction surfaces. The disc brake caliper has a parking braking system having a screw-nut screw group having a screw element and a nut screw element. A rotation of the screw element corresponds to an axial translation of the nut screw element with respect to the caliper body, the nut screw element being configured to bias the piston and at least one of the pads against one of the friction surfaces. A shield element defines a piston chamber and a cylinder chamber.

### CROSS-REFERENCE TO RELATED APPLICATION

This application claims priority to Italian Patent Application No. 102024000023868 filed on Oct. 25, 2024, the contents of which are incorporated by reference in their entirety.

### FIELD OF THE INVENTION

The present invention relates to a disc brake caliper, in particular for a disc brake comprising an electromechanical parking brake.

### PRIOR ART

In recent years, the development of electromechanical parking brakes (EPB) has focused on increasing their parking performance, both in terms of generated clamping force and service life.

In particular, current EPB devices are required to withstand at least 300,000 load cycles.

It has been highlighted that, in order to increase the service life of an EPB device, and thus its number of load cycles, a proper fluid sealing of the braking system plays a fundamental role.

Unwanted brake fluid leaks and undesired ingress of air from the outside cause the deterioration of EPB devices.

Indeed, in the absence of proper sealing, the brake fluid may enter in the gear motor chamber of the EPB device and damage its operation, for example by causing swelling of plastic gears or a short circuit of the motor.

Furthermore, due to the loss of optimal sealing, the consequent brake fluid seepage generates a vicious circle that further reduces the life of EPB devices.

To address these issues, current EPB devices are generally provided with one or more seals of the O-ring type, sometimes paired with a back-up ring configured to prevent extrusion of the O-ring rubber caused by the high pressure of the brake fluid.

This known solution is not optimal since the resulting fluid sealing depends heavily on the compression of the O-ring within the seat in which it is housed.

Moreover, since the O-ring is mounted directly on the screw shaft of the EPB device, the relative sliding and the heat generated during screw actuation cause significant wear and abrasion of the O-ring. The wear of the O-ring causes a significant reduction in its compression, causing brake fluid leakage and reducing the caliper life.

A further problem caused by the wear of the O-ring and its resulting loss of compression is represented by the ingress of air during the brake actuation step in the absence of pressurized brake fluid.

In fact, actuating the brake without the application of pressurized fluid causes the movement of the brake piston to generate a negative pressure at the EPB screw.

In the presence of a worn sealing system, the negative pressure causes air suction from the outside and leads to a spongy feeling at the pedal, reducing braking performance.

Attempts have been made to resolve these issues and increase the system sealing by placing several O-rings side by side.

However, placing multiple O-rings within the same seat has not proven effective because it does not solve the issues related to the high pressures of the brake fluid acting on the plurality of O-rings, which result in brake fluid seepage beyond the side-by-side O-rings.

### SUMMARY OF THE INVENTION

The purpose of the present invention is to provide a disc brake caliper comprising an improved parking braking system, and configured to overcome at least some of the drawbacks highlighted in the prior art.

These and other purposes are achieved by a disc brake caliper as described and claimed herein.

Preferred and advantageous embodiments of the present invention are also described.

### FIGURES

To better understand the invention and appreciate its advantages, some exemplary and non-limiting embodiments will be described hereinbelow, with reference to the accompanying figures, in which:

FIG. 1 is a perspective view of a disc brake caliper, along an axial section, according to a first embodiment of the present invention;

FIG. 2 is a side view of the disc brake caliper shown in FIG. 1;

FIG. 3 is a view along the section plane V-V of FIG. 2;

FIG. 4 is a partially sectioned perspective view of a shield element comprised in the disc brake caliper of FIG. 1;

FIG. 5 is a side view of a disc brake caliper, along an axial section, according to a second embodiment of the present invention;

FIG. 6 is a view along the section plane VI-VI of FIG. 5;

FIG. 7 is a side view of a disc brake caliper, along an axial section, according to a third embodiment of the present invention;

FIG. 8 is a view along the section plane VII-VII of FIG. 7;

FIG. 9 is a perspective exploded view of a nut screw element and a shield element comprised in the disc brake caliper of FIG. 7;

FIG. 10 is a side view of a disc brake caliper, along an axial section, according to a fourth embodiment of the present invention;

FIG. 10a is an enlarged view of a detail of FIG. 10;

FIG. 11 is a perspective exploded view of a shield element and of an annular retaining member comprised in the disc brake caliper of FIG. 10;

FIG. 12 is a sectional view of the shield element of FIG. 11;

FIG. 13 is a side view of a disc brake caliper, along an axial section, according to a fifth embodiment of the present invention;

FIG. 14 is a side view of a disc brake caliper, along an axial section, according to a sixth embodiment of the present invention;

FIG. 14a is an enlarged view of a detail of FIG. 14;

FIG. 15 is a side view of a disc brake caliper, along an axial section, according to a seventh embodiment of the present invention;

FIG. 15a is an enlarged view of a detail of FIG. 15;

FIG. 16 is a side view of a disc brake caliper, along an axial section, according to an eighth embodiment of the present invention;

FIG. 16a is an enlarged view of a detail of FIG. 16; and

FIG. 17 is a perspective exploded view of a screw element, a shield element, and a nut screw element comprised in the disc brake caliper of FIG. 16.

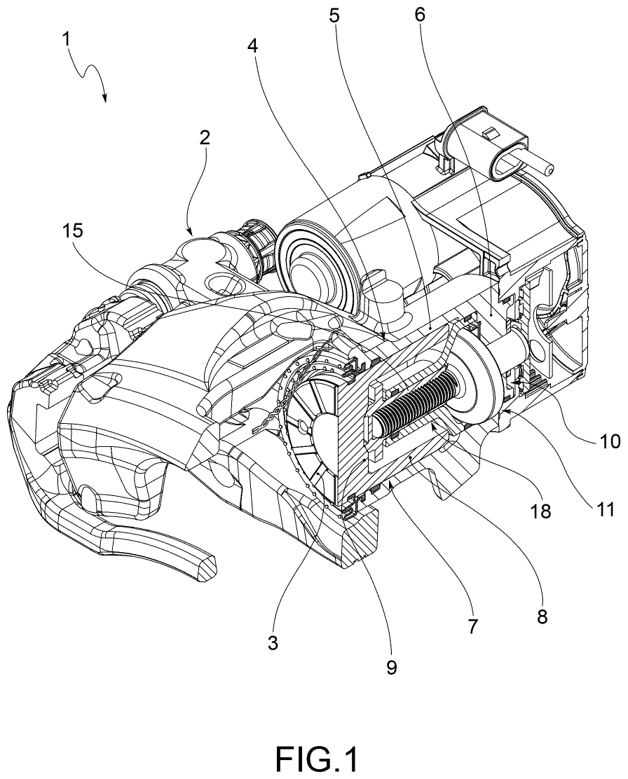

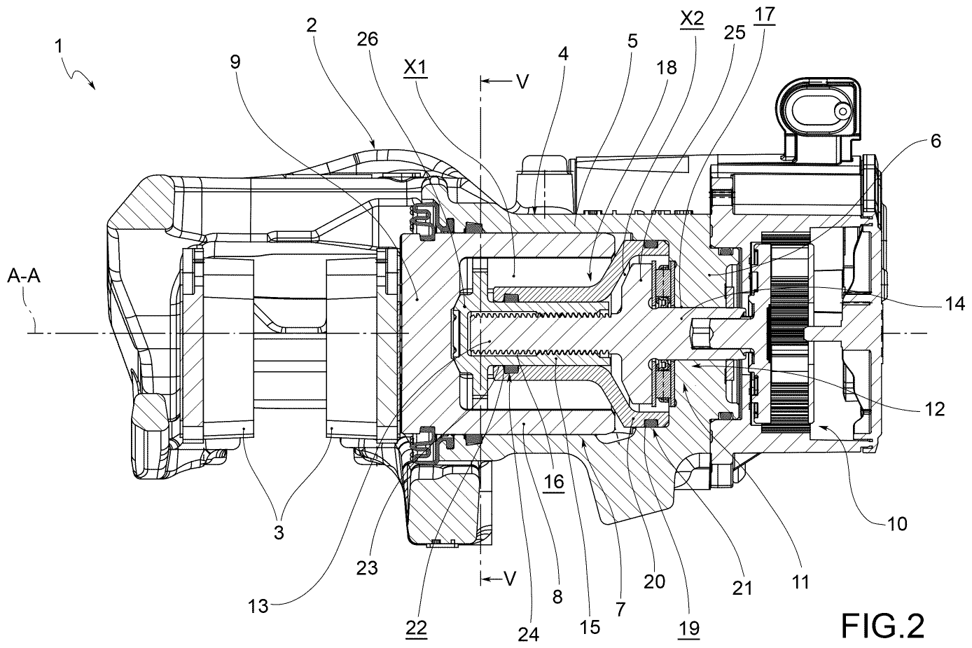

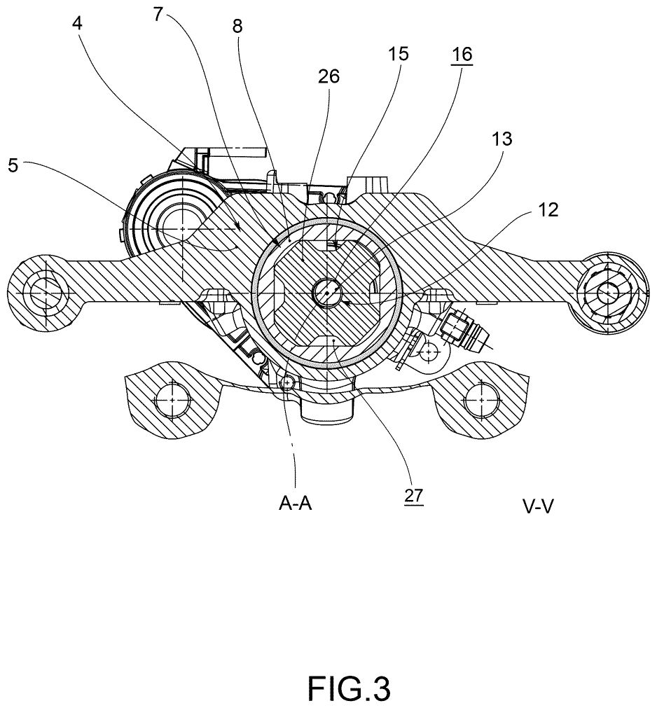

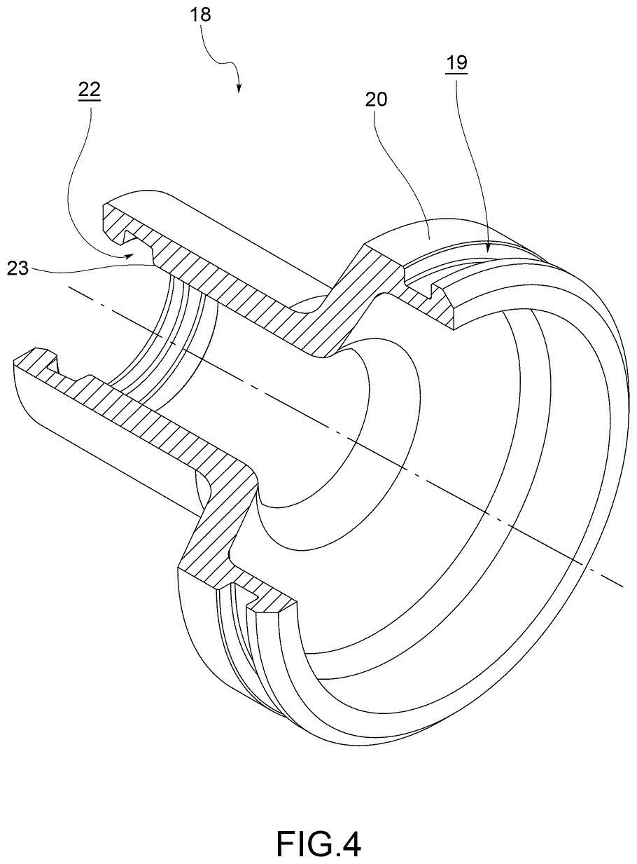

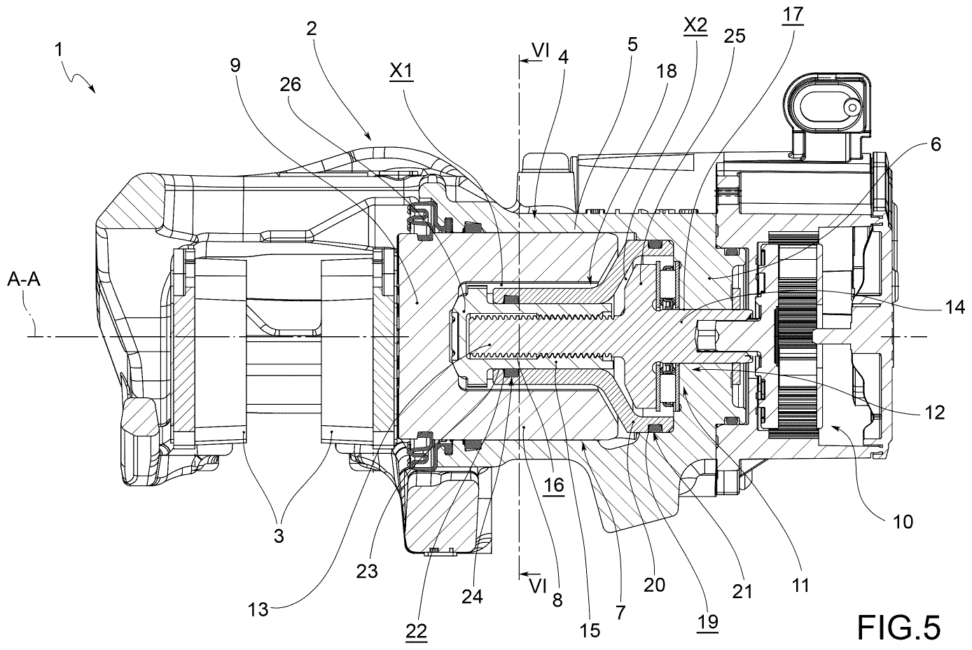

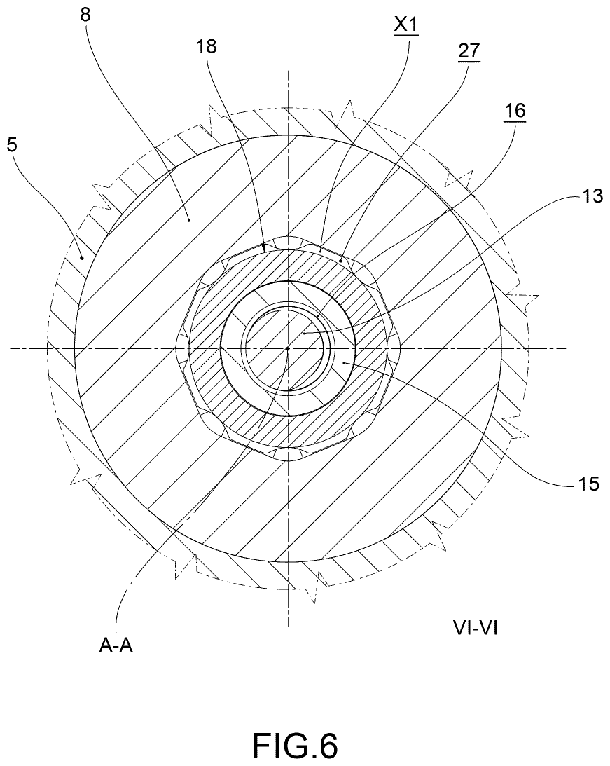

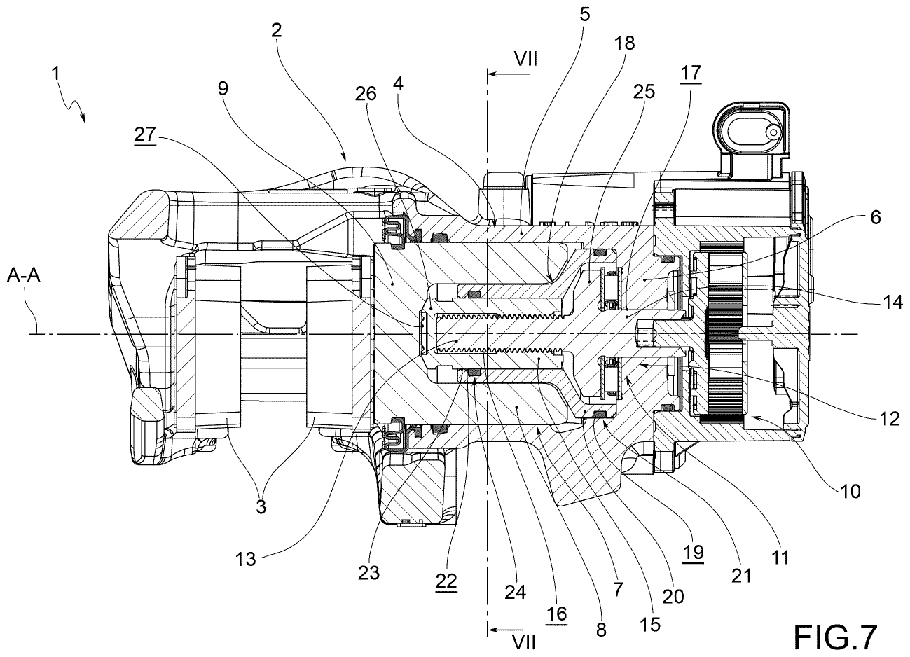

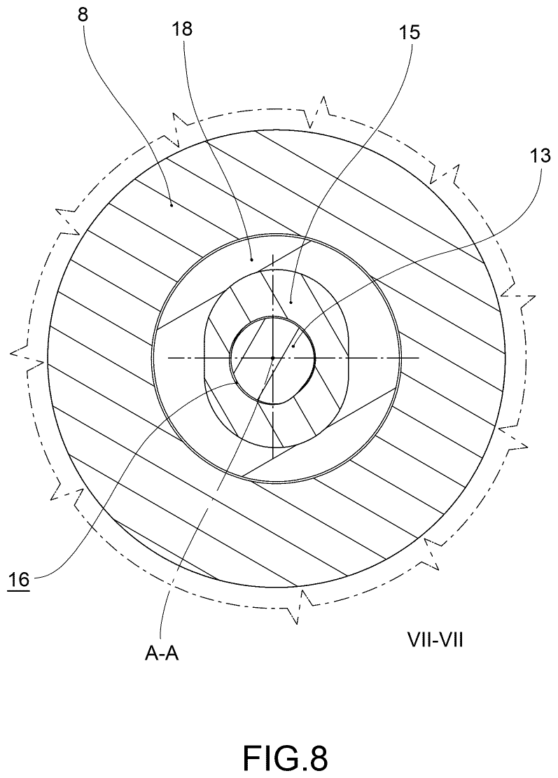

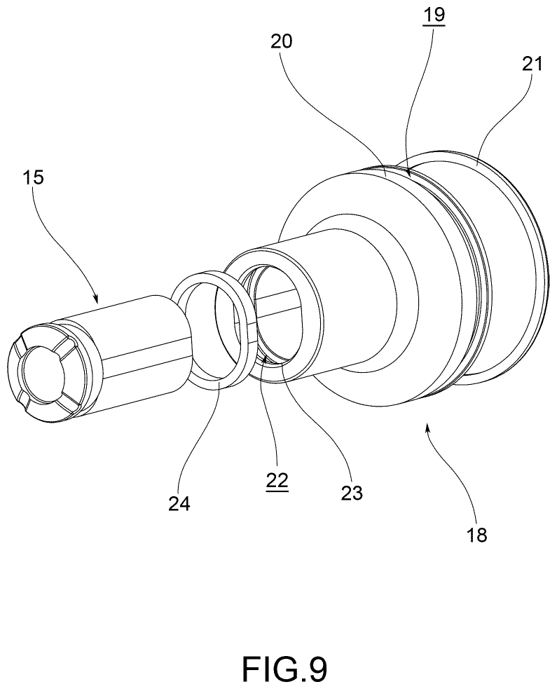

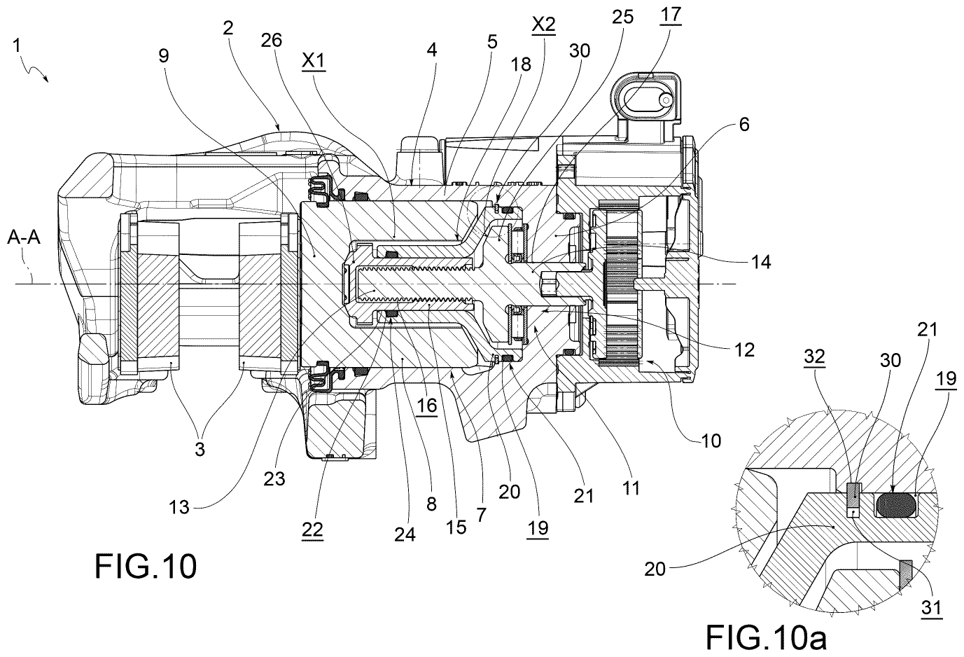

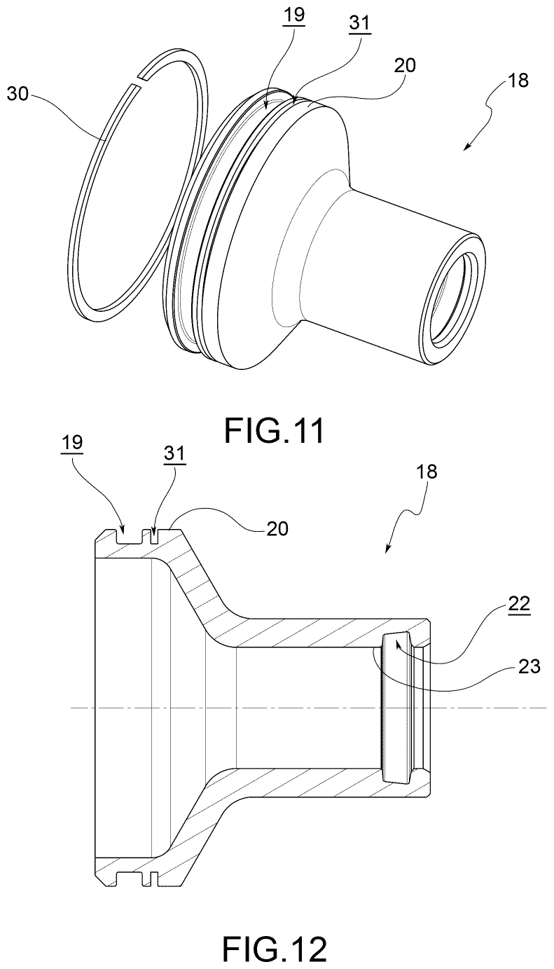

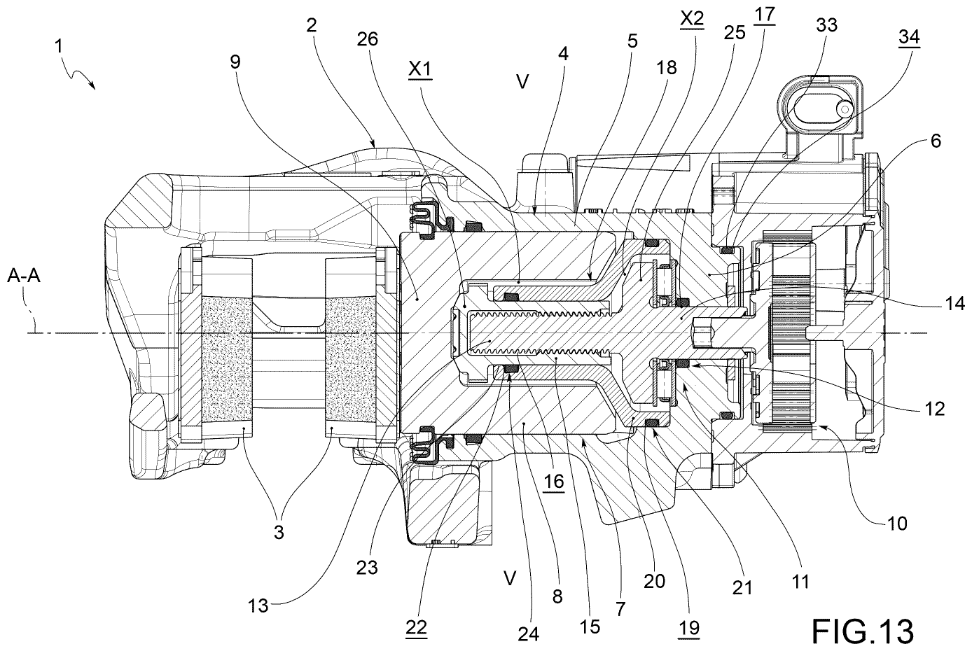

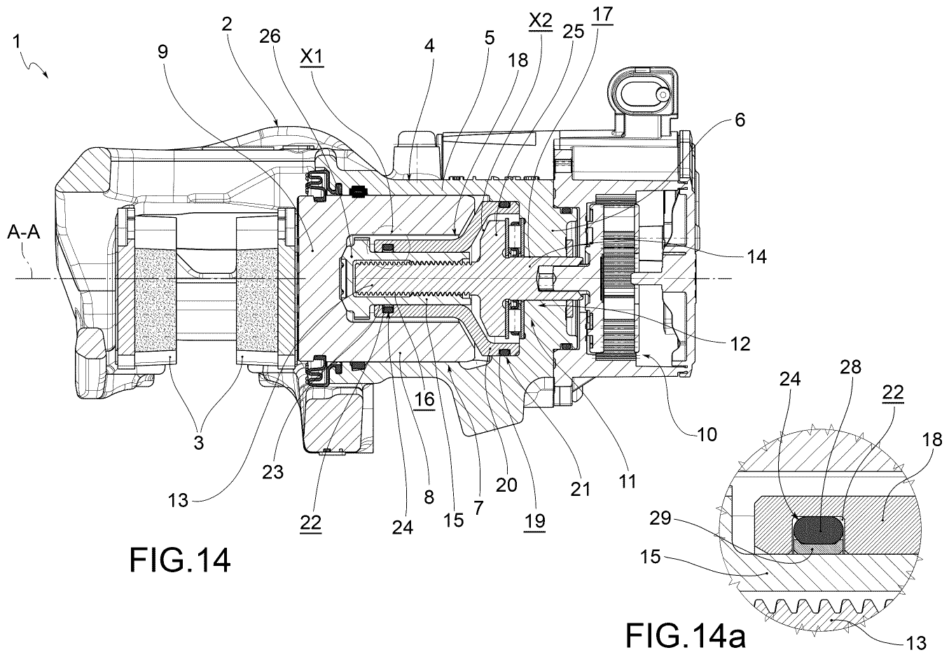

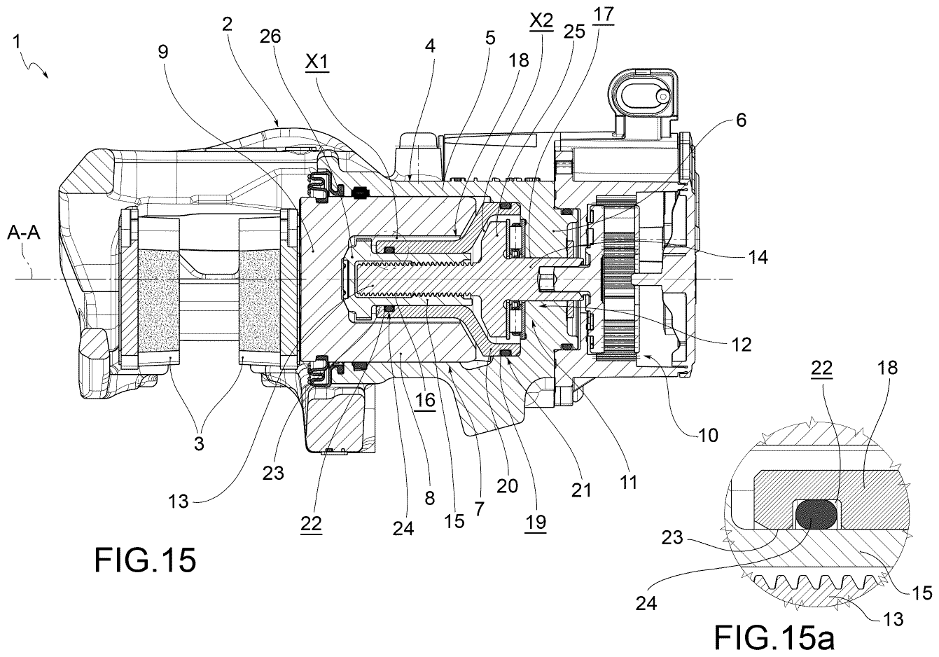

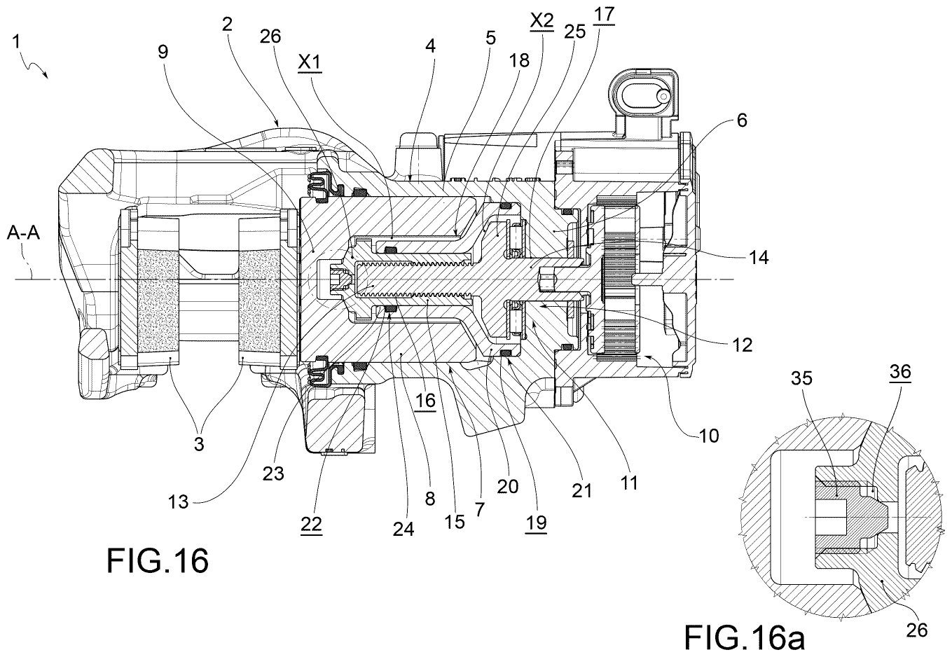

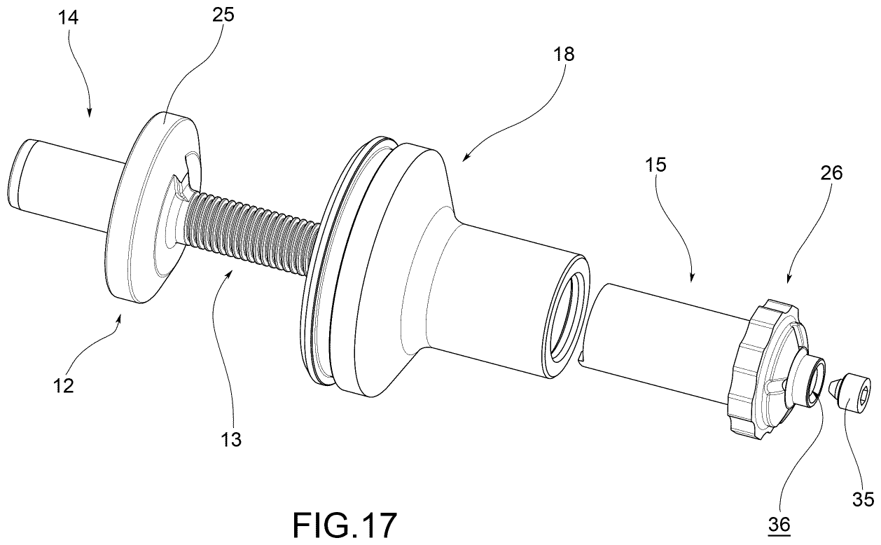

### DETAILED DESCRIPTION

With reference to the figures, a disc brake caliper is generally denoted by the reference number 1.

The disc brake caliper 1 comprises a caliper body 2 placed astride a brake disc having a rotation axis which defines an axial direction A-A, and opposite friction surfaces.

The disc brake caliper 1 comprises pads 3 housed in the caliper body 2 so as to be able to slide substantially in the axial direction A-A of the brake disc to act respectively on the opposite friction surfaces.

Furthermore, the disc brake caliper 1 comprises a cylinder 4, which forms a cylindrical wall 5 and a bottom wall 6 transverse to the cylindrical wall 5.

The disc brake caliper 1 further comprises a piston 7, which forms a side wall 8 and a thrust wall 9 substantially transverse to the side wall 8 and opposite the bottom wall 6 of the cylinder 4.

The piston 7 is housed inside the cylinder 4, and the side wall 8 of the piston 7 is suitable for sliding within the cylindrical wall 5 of the cylinder 4.

The piston 7 is configured to be actuated by pressurized brake fluid injectable into the cylinder 4, so as to bias at least one of the pads 3 against one of the friction surfaces of the brake disc, along a thrust direction substantially parallel to the axial direction A-A.

The disc brake caliper 1 further comprises a parking braking system 10 which comprises a rotating member.

The rotating member is rotatably housed within a rotation seat 17 formed in the bottom wall 6 of the cylinder 4, so that the rotating member is rotatable about a rotation axis substantially parallel to the axial direction A-A.

According to one embodiment, the rotating member comprises an axial locking ring 25. Preferably, the axial locking ring 25 is a flange which extends radially.

The axial locking ring 25 extends in a radial direction and is adapted to provide an abutment which engages the surface of the bottom wall 6. According to a preferred embodiment, the engagement between axial locking ring 25 and the surface of the bottom wall 6 is direct. According to a preferred embodiment, the engagement between the axial locking ring 25 and the surface of the bottom wall 6 is indirect, for example with a bearing positioned between the two components.

According to one embodiment, the parking braking system 10 comprises a screw-nut screw group 11 formed by a screw element 12 and a nut screw element 15.

According to a preferred embodiment, the rotating member constitutes the screw element 12.

In other words, it is the screw element 12 that extends rotationally free.

A rotation of the screw element 12 corresponds to a translation of the nut screw element 15, with respect to the caliper body 2, along a direction parallel to the axial direction A-A.

The nut screw element 15 is configured to bias at least one of the pads 3 against one of the friction surfaces of the brake disc.

According to a preferred embodiment, the screw-nut screw group 11 defines a thread, and the thread is of the irreversible type.

In accordance with the present invention, the screw element 12 comprises a threaded end 13 housed inside a threaded cavity 16 of the nut screw element 15.

According to a preferred embodiment, the threaded cavity 16 is blind. In other words, the screw element 12 interacts via the threading with the nut screw element 15. That is to say that the screw element 12 does not have direct interactions with the piston 7.

Moreover, the screw element 12 comprises a control end 14 housed within a rotation seat 17 formed in the bottom wall 6.

According to a preferred embodiment, the parking braking system 10 comprises an auxiliary seal 33 positioned in an auxiliary annular seat 34 made in the rotation seat 17, wherein the auxiliary seal 33 sealingly engages the control end 14.

In accordance with the present invention, the parking braking system 10 further comprises a shield element 18.

The shield element 18 defines a piston chamber X1 facing the thrust wall 9, preferably containing brake fluid, and a cylinder chamber X2 facing the bottom wall 6, preferably containing air or lubricating fluid preferably at ambient pressure.

In other words, within the space between the cylinder 4 and the piston 7, the shield element 18 is positioned so as to separate a piston chamber X1, in which the brake fluid is contained which, when pressurized, performs the thrust action, and a cylinder chamber X2 in which air or lubricant is contained, preferably not pressurized or at ambient pressure.

Thanks to the presence of the shield element 18, therefore, the components in the cylinder chamber X2 or facing the cylinder chamber X2 are spaced apart and are not influenced by the pressurized brake fluid.

In other words, the shield element 18 prevents leakages, or minimizes possible leakages, by defining two distinct chambers, mutually separated.

In accordance with the present invention, the shield element 18 is engaged with the nut screw element 15.

Moreover, the shield element 18 is shaped in such a way as to be spaced apart from the screw element 12, extending radially to engage the cylindrical wall 5.

In particular, therefore, the shield element 18 is not influenced by the movements of the screw element 12, from which it is spaced apart, while it is influenced by possible movements of the nut screw element 15. Similarly, the presence of the shield element 18 does not influence the movement of the screw element 12.

In further other words, between the shield element 18 and the screw element 12 there is a spacing gap.

According to a preferred embodiment, the shield element 18 comprises an outer annular seat 19 made on an outer surface 20.

Preferably, the shield element 18 comprises an outer seal 21 housed in the outer annular seat 19 to sealingly engage the cylindrical wall 5.

According to a preferred embodiment, the outer seal 21 is a static seal, for example an O-ring.

In accordance with the present invention, the parking braking system 10 further comprises an annular retaining member 30.

According to a preferred embodiment, the shield element 18 comprises the annular retaining member 30 which extends radially from the shield element 18 to the cylindrical wall 5 to engage them with each other.

In an alternative embodiment, the cylindrical wall 5 comprises the annular retaining member 30 which extends radially from the cylindrical wall 5 to the shield element 18 to engage them with each other.

According to a preferred embodiment, the annular retaining member 30 is such as to block axial movements of the shield element 18 with respect to the cylindrical wall 5.

In particular, the annular retaining member 30 is housed in a first annular half-groove 31 made in the shield element 18, preferably in its outer surface 20, and in a second annular half-groove 32 made in the cylindrical wall 5.

According to a preferred embodiment, the annular retaining member 30 is positioned proximal to the outer seal 21.

According to a preferred embodiment, the annular retaining member 30 is a Seeger ring.

According to what has been stated above, preferably, the screw element 12 comprises an axial locking ring 25 which extends in a radial direction and is suitable for providing an abutment that engages the bottom wall 6. The shield element 18 is shaped to engage the cylindrical wall 5 in a region radially external to the axial locking ring 25.

According to a preferred embodiment, the shield element 18 comprises an inner annular seat 22 made on an inner surface 23. Preferably, the shield element 18 comprises an inner seal 24 housed in the inner annular seat 22 to sealingly engage the nut screw element 15.

According to a preferred embodiment, the inner annular seat 22 has a substantially square section.

According to a preferred embodiment, the inner seal 24 is an O-ring.

According to a preferred embodiment, the inner seal 24 is a square section seal.

According to a preferred embodiment, the inner seal 24 comprises an O-ring 28 and a back-up ring 29. The back-up ring 29 is interposed between the O-ring 28 and the nut screw element 15, and is made of a material less deformable than the material constituting the O-ring. Optionally, the back-up ring 29 is made of a polymeric material, for example polytetrafluoroethylene (PTFE), or of a polymeric material with PTFE filler in the polymer matrix.

According to a preferred embodiment, the nut screw element 15 and the piston 7 are mutually engaged so as to prevent reciprocal rotations.

Preferably, the nut screw element 15 and the piston 7 are coupled by shape coupling.

According to a preferred embodiment, the nut screw head 26 and the side wall 8 are coupled by shape coupling.

According to a preferred embodiment, the nut screw element 15 and the shield element 18 are mutually engaged so as to prevent reciprocal rotations.

Preferably, the nut screw element 15 and the shield element 18 are coupled by shape coupling.

According to a preferred embodiment, the nut screw element 15 and the piston 7 are mutually engaged so as to prevent reciprocal rotations.

According to a preferred embodiment, in the disc brake caliper 1 there is only one of the above-mentioned shape couplings, with the purpose of preventing rotations of the shield element 18.

According to what has been stated above, the shape couplings are made in such a way as to allow insertion (and possible translational movements) of the components along the axial direction A-A, while at the same time preventing possible rotational movements about the axis. In further other words, the only component to which rotation is allowed is, indeed, the screw element 12.

According to a preferred embodiment, in the shape couplings, a free space is always left so that pressurized brake fluid can flow.

Preferably, according to a preferred embodiment, the disc brake caliper 1 comprises at least one fluid channel 27.

Preferably, the disc brake caliper 1 comprises a plurality of fluid channels 27 angularly spaced apart.

According to a preferred embodiment, the fluid channels 27 comprise an axial section, which extends substantially parallel to the axis.

According to a preferred embodiment, the fluid channels 27 comprise a radial section, which extends substantially radially with respect to the axis.

According to a preferred embodiment, the fluid channels 27 are made between the piston 7 and the nut screw element 15 and/or the shield element 18.

According to a preferred embodiment, the fluid channels 27 are made between the piston 7 and the nut screw element 15, for example between the side wall 8 and the nut screw element 15 and/or between the thrust wall 9 and the nut screw element 15.

Preferably, the nut screw element 15 is specifically shaped.

Preferably, the piston 7, i.e. the side wall 8 and/or the thrust wall 9, is specifically shaped.

According to a preferred embodiment, the fluid channels 27 are made between the piston 7 and the shield element 18, for example between the side wall 8 and the shield element 18.

Preferably, the shield element 18 is specifically shaped.

Preferably, the piston 7, i.e. the side wall 8, is specifically shaped.

According to a preferred embodiment, the nut screw element 15 comprises a plug 35 suitable for closing a nut screw hole 36 made in the nut screw head 26.

Preferably, the plug 35 engages the nut screw hole 36 by threading.

According to a preferred embodiment, the cylinder chamber X2 is refillable with lubricating liquid through the nut screw hole 36 with axial plug 35.

In the present description, the screw-nut screw group 11 has been described as comprising a screw element 12 comprising a threaded end and the nut screw element 15 comprising a threaded cavity 16; however, it is clarified that alternative embodiments of the present invention are also possible, presenting an inversion of means: i.e., presenting a threaded end instead of a threaded cavity and vice versa; that is to say that embodiments are possible in which where previously a screw was referred to, a nut screw is instead found, and vice versa.

Innovatively, the disc brake caliper object of the present invention fully fulfils the intended purpose.

Advantageously, the disc brake caliper fully exploits the benefits associated with the screw-nut screw group, and thanks to the shield element prevents the pressurized brake fluid or the fluid from the pressurized chamber from reaching the screw element.

Advantageously, the shield element is spaced apart from the screw element and therefore is not influenced by its movements, for example in the axial direction.

Advantageously, the outer seal is a static seal.

Advantageously, the inner seal is a dynamic seal.

Naturally, those who are skilled in the art will be able to make modifications or adaptations to the present invention, without however departing from the scope of protection as described and claimed herein.

What is claimed is:

1. A disc brake caliper comprising a caliper body arranged straddling a brake disc having a rotation axis defining an axial direction and opposite friction surfaces, the disc brake caliper comprising pads accommodated in the caliper body so as to slide in the axial direction with respect to the brake disc to act on the opposite friction surfaces, respectively,
the disc brake caliper comprising:
a cylinder forming a cylindrical wall and a bottom wall transverse to the cylindrical wall;
a piston forming a side wall and a thrust wall transverse to the side wall and opposite to the bottom wall of the cylinder;
wherein the piston is accommodated inside the cylinder, and the side wall of the piston is adapted to slide within the cylindrical wall of the cylinder;
wherein the piston is configured to be biased by a pressurized brake fluid injectable into the cylinder so as to bias at least one of the pads against one of the opposite friction surfaces of the brake disc, along a thrust direction substantially parallel to the axial direction;
the disc brake caliper further comprising a parking-braking system which comprises:
a screw-nut screw group comprising a screw element and a nut screw element wherein the screw element is rotational about a rotation axis substantially parallel to the axial direction and comprises a threaded end housed inside a threaded cavity of the nut screw element and a control end housed inside a rotation seat formed in the bottom wall, wherein a rotation of the screw element corresponds to an axial translation of the nut screw element with respect to the caliper body, the nut screw element being configured to bias the piston, and thus at least one of the pads against one of the opposite friction surfaces of the brake disc; and
a shield element engaged with the nut screw element shaped to be spaced apart from the screw element and extending radially to engage the cylindrical wall, the shield element defining a piston chamber facing the thrust wall and a cylinder chamber facing the bottom wall.

2. The disc brake caliper of claim 1, wherein the shield element comprises an outer annular seat formed on an outer surface and wherein the shield element further comprises an outer seal housed in the outer annular seat to sealingly engage the cylindrical wall.

3. The disc brake caliper of claim 2, wherein the outer seal is a static seal.

4. The disc brake caliper of claim 1, wherein the screw element comprises an axial locking ring extending in a radial direction and adapted to provide an abutment which engages the bottom wall and wherein the shield element is shaped to engage the cylindrical wall in a region radially outside the axial locking ring.

5. The disc brake caliper of claim 1, wherein the shield element comprises an inner annular seat formed on an inner surface and wherein the shield element comprises an inner seal housed in the inner annular seat to sealingly engage the nut screw element.

6. The disc brake caliper of claim 5, wherein the inner annular seat has a substantially square section.

7. The disc brake caliper of claim 5 wherein the inner seal is an O-ring, or is a square section seal, or comprises an O-ring and a back-up ring interposed between the O-ring and the nut screw element.

8. The disc brake caliper of claim 1, wherein the nut screw element and the piston are mutually engaged so as to prevent mutual rotation.

9. The disc brake caliper of claim 1, wherein the nut screw element and the shield element are mutually engaged so as to prevent mutual rotations.

10. The disc brake caliper of claim 9, wherein the nut screw element and the shield element are coupled by shape coupling.

11. The disc brake caliper of claim 9 wherein the nut screw element and the piston are mutually engaged so as to prevent mutual rotations.

12. The disc brake caliper of claim 1, wherein the screw-nut screw group defines an irreversible-type thread.

13. The disc brake caliper of claim 1, wherein the parking-braking system further comprises an annular retaining member, which extends radially between the shield element and the cylindrical wall to engage the shield element and the cylindrical wall with each other.

14. The disc brake caliper of claim 1, wherein the parking-braking system comprises an auxiliary seal positioned in an auxiliary annular seat made in the rotation seat and wherein the auxiliary seal sealingly engages the control end.

15. The disc brake caliper of claim 1, wherein the nut screw element comprises a plug adapted to close a nut screw hole.

16. The disc brake caliper of claim 1, wherein the piston chamber contains brake fluid and the cylinder chamber contains air or lubricating fluid.

17. The disc brake caliper of claim 3, wherein the outer seal is an O-ring.

18. The disc brake caliper of claim 8, wherein the nut screw element and the piston are coupled by shape coupling.

19. The disc brake caliper of claim 8, wherein a nut screw head and the side wall are coupled by shape coupling.

20. The disc brake caliper of claim 15, wherein the nut screw hole is made in a nut screw head.
